(19) United States
(12) Patent Application Publication
(10) Pub. No.: US 2022/0351390 A1
(43) Pub. Date: Nov. 3, 2022

(54) METHOD FOR GENERATING MOTION CAPTURE DATA, ELECTRONIC DEVICE AND STORAGE MEDIUM

(71) Applicant: BEIJING BAIDU NETCOM SCIENCE TECHNOLOGY CO., LTD., Beijing (CN)

(72) Inventor: Yang ZHAO, Beijing (CN)

(73) Assignee: BEIJING BAIDU NETCOM SCIENCE TECHNOLOGY CO., LTD., Beijing (CN)

(21) Appl. No.: 17/866,934

(22) Filed: Jul. 18, 2022

(30) Foreign Application Priority Data
Jul. 20, 2021 (CN) 202110821923.3

(51) Int. Cl. G06T 7/20; G06T 7/70; G06V 20/40; G06V 10/25

(52) U.S. Cl. CPC G06T 7/20; G06T 7/70; G06V 20/46; G06V 10/25

(57) ABSTRACT

A method for generating motion capture data, an electronic device and a storage medium are provided, relating to fields of computer technologies such as augmented reality and deep learning, and in particular, to a field of computer vision. The method includes processing a plurality of video frames comprising a target object to obtain a key point coordinate of the target object in at least one of the video frames; and obtaining, as motion capture data for the target object, a posture information of the target object according to the plurality of video frames and the key point coordinate of the target object in the video frame.

This application is claims priority to Chinese Patent Application No. 202110821923.3 filed on Jul. 20, 2021, which is incorporated herein in its entirety by reference.

### TECHNICAL FIELD

The present disclosure relates to fields of computer technologies such as augmented reality and deep learning, and in particular, to a field of computer vision.

### BACKGROUND

Computer vision involves the automatic extraction, analysis and understanding of useful information from a single image or a sequence of images, relating to the development of theoretical and algorithmic foundations in order to achieve automatic visual understanding. Image data may take many forms, such as video sequences, images from multiple cameras, or multi-dimensional data from medical scanners. Computer vision may be applied in the fields of scene reconstruction, event detection, video tracking, object recognition, three-dimensional posture estimation, learning, indexing, motion estimation, image restoration and the like.

### SUMMARY

The present disclosure provides a method for generating motion capture data, an electronic device and a storage medium.

According to an aspect of the present disclosure, a method for generating motion capture data is provided, the method including: processing a plurality of video frames including a target object to obtain a key point coordinate of the target object in at least one of the video frames; and obtaining, as motion capture data for the target object, a posture information of the target object according to the plurality of video frames and the key point coordinate of the target object in the video frame.

According to an aspect of the present disclosure, an electronic device is provided, including: at least one processor; and a memory communicatively connected with the at least one processor; wherein the memory stores instructions executable by the at least one processor, and the instructions, when executed by the at least one processor, cause the at least one processor to perform the herein mentioned method for generating motion capture data.

According to an aspect of the present disclosure, a non-transitory computer-readable storage medium storing computer instructions is provided, wherein the computer instructions are configured to cause the computer to perform the herein mentioned method for generating motion capture data.

It should be understood that the content described in this section is not intended to identify key or important features of embodiments of the present disclosure, nor is it intended to limit the scope of the present disclosure. Other features of the present disclosure will be easily understood through the following description.

### BRIEF DESCRIPTION OF THE DRAWINGS

The drawings are used for better understanding of the present solution, and do not constitute a limitation to the present disclosure.

FIG. 1 schematically shows an exemplary system architecture to which a method and an apparatus for generating motion capture data may be applied according to embodiments of the present disclosure;

FIG. 2 schematically shows a flowchart of a method for generating motion capture data according to embodiments of the present disclosure;

FIG. 3 schematically shows a principle diagram of a first neural network model according to embodiments of the present disclosure;

FIG. 4 schematically shows a structural diagram of a second neural network model according to embodiments of the present disclosure;

FIG. 5 schematically shows a principle diagram of a third neural network model according to embodiments of the present disclosure;

FIG. 6 schematically shows a schematic diagram of determining optimized motion capture data based on an optimization function according to embodiments of the present disclosure;

FIG. 7 schematically shows a schematic diagram of generating motion capture data based on a video containing a human body according to embodiments of the present disclosure;

FIG. 8 schematically shows a block diagram of an apparatus for generating motion capture data according to embodiments of the present disclosure; and

FIG. 9 shows a schematic block diagram of an example electronic device that may be used to implement embodiments of the present disclosure.

### DETAILED DESCRIPTION OF EMBODIMENTS

Hereinafter, embodiments of the present disclosure will be described with reference to the drawings. It should be understood, however, that these descriptions are merely exemplary and are not intended to limit the scope of the present disclosure. In the following detailed description, for ease of interpretation, many specific details are set forth to provide a comprehensive understanding of embodiments of the present disclosure. However, it is clear that one or more embodiments may also be implemented without these specific details. In addition, in the following description, descriptions of well-known structures and technologies are omitted to avoid unnecessarily obscuring the concepts of the present disclosure.

Collecting, storing, using, processing, transmitting, providing, and disclosing etc. of the personal information of the user involved in the present disclosure all comply with the relevant laws and regulations, are protected by essential security measures, and do not violate the public order and morals. According to the present disclosure, personal information of the user is acquired or collected after being authorized or permitted by the user.

Virtual character refers to a virtual avatar for a user to perform on line entertainment, virtual customer service and social networking with the real identity of the user being hidden. After the current virtual character is generated, it is required to perform animation design of the current virtual character by professional model designers for user control or automatic playback. The specific implementation mainly includes a manual editing and a motion capture. The manual editing is achieved by senior model designers using professional tools to perform animation editing for each key frame. The motion capture refers to acquiring data while actors wearing professional equipment perform motions.

During the process of implementing the concept of the present disclosure, the inventor found that the manual editing method is limited by the investment of human labor and the investment of time, and has large cost in communication. In addition to the large investment of human labor and time, the motion capture method has large cost in the investment of site and equipment, especially for optical solutions of high-precision and inertial navigation solutions of medium-precision. The using of motion capture systems also has high requirement.

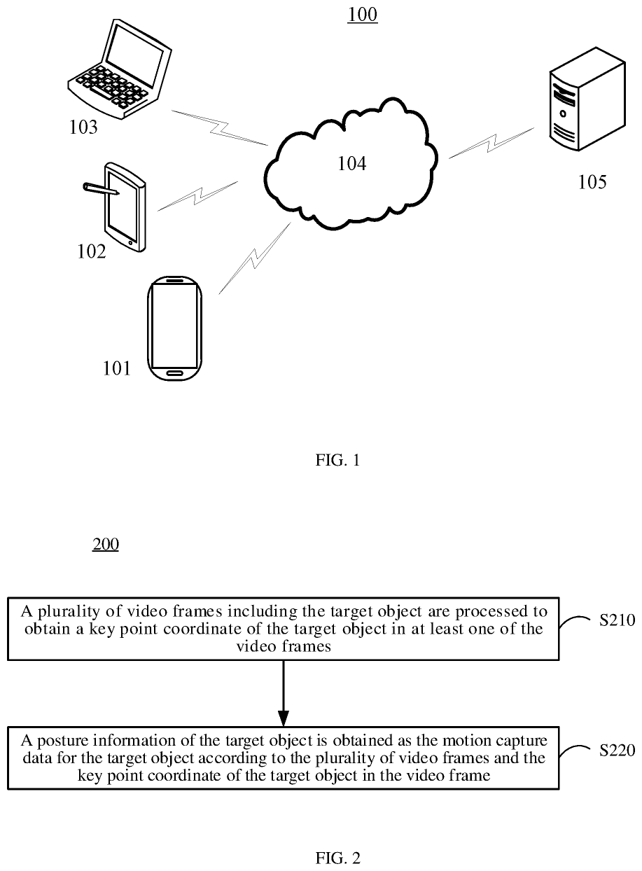

FIG. 1 schematically shows an exemplary system architecture to which a method and an apparatus for generating motion capture data may be applied according to embodiments of the present disclosure.

It should be noted that FIG. 1 is only an example of a system architecture of embodiments of the present disclosure, so as to help those skilled in the art to understand the technical content of the present disclosure, but it does not mean that embodiments of the present disclosure is not applicable in other devices, systems, environments or scenes. In another embodiment, the exemplary system architecture to which the method and the apparatus for generating motion capture data may be applied may include a terminal device. However, the terminal device may implement the method and the apparatus for generating motion capture data provided by embodiments of the present disclosure without interacting with a server.

As shown in FIG. 1, the system architecture 100 according to this embodiment may include terminal devices 101, 102, and 103, a network 104 and a server 105. The network 104 is a medium used to provide a communication link between the terminal devices 101, 102, 103 and the server 105. The network 104 may include various types of connection, such as wired and/or wireless communication links, and the like.

The user may use the terminal devices 101, 102, 103 to interact with the server 105 through the network 104 to receive or send messages and the like. Various communication client applications may be installed in the terminal devices 101, 102 and 103, such as knowledge reading applications, web browser applications, search applications, instant messaging tools, video client and/or social platform software, and the like (only example).

The terminal devices 101, 102, 103 may be various electronic devices having a display screen and supporting web browsing, including but not limited to smart phones, tablet computers, laptop computers, desktop computers, and the like.

The server 105 may be a server that provides various services, such as a background management server (just an example) that provides support for the content browsed by the user using the terminal devices 101, 102, and 103. The background management server may analyze and process the received user request and other data, and feedback the processing result (such as web pages, information, or data obtained or generated according to user request) to the terminal device. The server may be a cloud server, also known as a cloud computing server or a cloud host. The cloud server is a host product in the cloud computing service system to solve the defects of difficult management and weak business expansion in traditional physical host and Virtual Private Server (VPS). The server may also be a server of a distributed system, or a server combined with a block chain.

It should be noted that, the method for generating motion capture data provided by embodiments of the present disclosure may generally be executed by the terminal device 101, 102, or 103. Correspondingly, the apparatus for generating motion capture data provided by embodiments of the present disclosure may also be provided in the terminal device 101, 102, or 103.

Alternatively, the method for generating motion capture data provided by embodiments of the present disclosure may also be generally performed by the server 105. Correspondingly, the apparatus for generating motion capture data provided by embodiments of the present disclosure may generally be provided in the server 105. The method for generating motion capture data provided by embodiments of the present disclosure may also be performed by a server or a cluster of servers that is different from the server 105 and may communicate with the terminal devices 101, 102, 103 and/or the server 105. Correspondingly, the apparatus for generating motion capture data provided by embodiments of the present disclosure may also be provided in a server or server cluster that is different from the server 105 and may communicate with the terminal devices 101, 102, 103 and/or the server 105.

For example, when motion capture data is desired to be generated, a plurality of video frames including a target object may be acquired based on the terminal devices 101, 102 and 103. Then, the plurality of acquired video frames including the target object are sent to the server 105, and the server 105 processes the plurality of video frames including the target object to obtain a key point coordinate of the target object in at least one of the video frames. Then, according to the plurality of video frames and the key point coordinate of the target object in the video frame, a posture information of the target object is obtained as the motion capture data for the target object. Alternatively, the server or the cluster of servers capable of communicating with the terminal devices 101, 102, 103 and/or the server 105 analyzes and processes the plurality of video frames including the target object, and generates the motion capture data.

It should be understood that the numbers of terminal device(s), network(s) and server(s) in FIG. 1 are only illustrative. According to implementation requirements, the numbers of terminal device(s), network(s) and server(s) may be set as desired in practice.

It should be noted that, in this embodiment, the object performing the method for generating motion capture data may obtain the video frame including the target object in various manners, which are legal and compliant with related rules, from the public. For example, the video frame may be obtained from a public dataset, or obtained from a user with the authorization of the user.

FIG. 2 schematically shows a flowchart of a method for generating motion capture data according to embodiments of the present disclosure.

As shown in FIG. 2, the method includes operations S210 to S220.

In operation S210, a plurality of video frames including the target object are processed to obtain a key point coordinate of the target object in at least one of the video frames.

In operation S220, a posture information of the target object is obtained as the motion capture data for the target object according to the plurality of video frames and the key point coordinate of the target object in the video frame.

According to embodiments of the present disclosure, the target object may include at least one of a human body and other movable objects. The plurality of video frames, for example, represent a sequence of images for one or more videos. Different videos may have different resolutions and formats. The formats of video includes, for example, MP4 (MPEG-4 Part 14) which is a multimedia computer file format using MPEG-4, MPEG (Moving Picture Coding Experts Group), DAT (Data File), and the like.

According to embodiments of the present disclosure, the key point is, for example, a feature point that may represent a basic motion of the target object. For example, taking the target object being a human body as an example, the key point is, for example, a skeleton point that may reflect the posture of the human body, such as neck, head, shoulders, elbows, knees, and the like. Taking the target object being a cat or a dog as an example, the key point may include, for example, head, torso, legs, tail, and the like. By setting a preset coordinate system for the target object, the coordinate of each key point in the target object may be determined for example. Coordinates in the preset coordinate system may be length coordinates, pixel coordinates, and the like, which are not limited herein. The key point coordinate is represented, for example, as a two-dimensional pixel coordinate. In embodiments, the key point coordinate is, for example, a three-dimensional coordinate. In this embodiment, the video or video frame relating to the human body may come from a public data set, or the acquisition of the video or video frame relating to the human body is authorized by the user corresponding to the video or video frame.

According to embodiments of the present disclosure, the posture information is represented, for example, in a form of three-dimensional coordinate. The three-dimensional coordinate may be expressed as a coordinate point relative to a preset three-dimensional coordinate system, or may be expressed as a change amount relative to a reference key point coordinate corresponding to a preset reference posture. The change amount may be expressed as a rotation angle, a change of length, or the like of the target coordinate relative to the reference coordinate.

According to embodiments of the present disclosure, processing the plurality of video frames including the target object to obtain the key point coordinate of the target object in the at least one of the video frames may be implemented by a trained first neural network model. The first neural network model may be trained according to the video frame, a real key point coordinate of the target object in the video frame, and a predicted key point coordinate of the target object in the video frame which is obtained by processing the video frame. Obtaining the posture information of the target object according to the plurality of video frames and the key point coordinate of the target object in the video frame may be implemented by a trained second neural network model. The second neural network model may be trained according to the plurality of video frames, the real key point coordinate of the target object in each video frame, the real posture information of the target object in each video frame, and the predicted key point coordinate of the target object in each video frame which is obtained by processing each video frame.

It should be noted that the first neural network model and the second neural network model in this embodiment are not specific to a certain target object, and do not reflect an object information of the certain target object. For example, the first neural network model and the second neural network model do not reflect a personal information of a specific human body. The first neural network model and the second neural network model obtained through this step contain the object information indicated by the target object. The construction of the first neural network model and the second neural network model is performed after being authorized by the relevant object or user, and the construction process conforms to relevant laws and regulations.

In the above-mentioned embodiments of the present disclosure, there is provided a technology for acquiring motion capture data through video input, which is directly used to drive the virtual character or is simply edited and then used to drive the virtual character. This technology reduces the requirements in terms of time, professional ability, site and equipment investment, so as to allow ordinary users to generate and edit the motion of 3D models at any place.

The method shown in FIG. 2 will be further described below with reference to specific embodiments.

According to embodiments of the present disclosure, the method for generating motion capture data further includes: obtaining an attribute information of the target object in the video frame according to the key point coordinate of the target object in the video frame; and determining the motion capture data for the target object according to the key point coordinate, the attribute information and the posture information.

According to embodiments of the present disclosure, the attribute information may include an interaction information between the target object and the environment where the target object is located. For example, the attribute information may include an information of contact between the target object and at least one of a ground, a wall, and other predetermined media. The attribute information may be represented by a determinable attribute value. For example, when the target object is in contact with the ground, the attribute value may be represented by 0; and when the target object is not in contact with the ground, the attribute value may be represented by 1. Specifically, when the target object is not in contact with the ground, a distance between the target object and the ground may also be used as a representation of the attribute value.

According to embodiments of the present disclosure, obtaining the attribute information of the target object in the video frame according to the key point coordinate of the target object in the video frame may be implemented by a trained third neural network model. The third neural network model may be trained according to the video frame, the real key point coordinate of the target object in the video frame, the real attribute information of the target object in the video frame, and the predicted attribute information of the target object in the video frame which is obtained by processing the video frame.

According to embodiments of the present disclosure, the motion capture data may be directly determined according to the posture information, be determined according to a combination of the posture information and the attribute information, or be determined according to key point coordinate, the attribute information and the posture information. The determination process may be implemented in combination with a predefined function. The predefined function may include, for example, at least one of a function constructed according to the posture information, a function constructed according to the posture information and the attribute information, and a function constructed according to the key point coordinate, the attribute information and the posture information. The determination process may also be implemented in conjunction with a trained neural network model having a function of constructing the motion capture data.

It should be noted that the third neural network model in this embodiment is not specific to a certain target object, and does not reflect an object information of the certain target object. For example, the third neural network model does not reflect a personal information of a specific human body. The third neural network model obtained through this step contains the object information indicated by the target object. The construction of the third neural network model is performed after being authorized by the relevant object or user, and the construction process conforms to relevant laws and regulations.

In the above-mentioned embodiments of the present disclosure, introducing of the attribute information may further optimize the positioning of the target object, thereby improving the accuracy of the motion capture data.

According to embodiments of the present disclosure, the processing a plurality of video frames including a target object to obtain a key point coordinate of the target object in at least one of the video frames includes: performing an object detection on the plurality of video frames to determine the target object in the at least one of the video frames; and detecting the target object to obtain the key point coordinate of the target object.

According to embodiments of the present disclosure, a target detection technique may be used to perform the target detection on the plurality of video frames to determine the target object in the at least one of the video frames. Taking the target object being a human body as an example, the human body detection technology may be used to locate the human body in the video frame.

According to an embodiment of the present disclosure, a key point detection technology may be used to detect the target object in the video frame to obtain the key point coordinate of the target object. Taking the target object being a human body as an example, for example, the key point detection technology may be used to determine a pixel coordinate of key skeleton point of the human body.

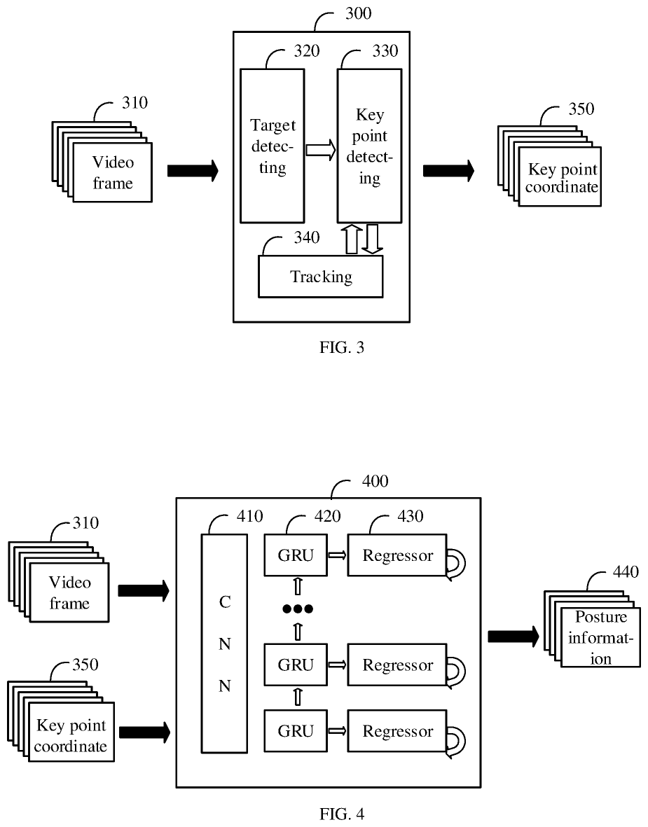

FIG. 3 schematically shows a principle diagram of a first neural network model according to embodiments of the present disclosure.

As shown in FIG. 3, the first neural network model 300 may take a video frame 310 containing a target object as input. The target object in the video frame is located by using a target detecting module 320 in combination with a target detection technology. A key point is extracted frame by frame by using a key point detecting module 330 in combination with the key point detection technology. A tracking of the corresponding key point in the video frame is achieved by using a tracking module 340, so as to obtain the key point coordinate 350 of the video frame.

According to embodiments of the present disclosure, taking the target object being a human body as an example, the key point coordinate may be a pixel coordinate of a target skeleton point used to represent the target object in the video frame. The target skeleton point may be a key skeleton point of the human body determined above. That is, the method of processing the plurality of video frames including a target object to obtain the key point coordinate of the target object in at least one of the video frames may be applied to the field of human posture detection. By using the first neural network model shown in FIG. 3, for example, the pixel coordinate of the key skeleton point of the human body in the input video frame including the human body may be obtained, so that the two-dimensional posture of the human body in the video frame may be preliminarily determined.

In the above-mentioned embodiments of the present disclosure, intelligent extraction of the key point coordinate of the target object in the video frame is implemented, which effectively saves the human labor and the time cost in obtaining the motion capture data.

According to embodiments of the present disclosure, the obtaining a posture information of the target object according to the plurality of video frames and the key point coordinate of the target object in the video frame includes: extracting the target object in the video frame according to the key point coordinate of the target object in the video frame, to obtain a target image; performing a feature extraction on the target image to obtain a target feature; and determining the posture information according to the target feature and a reference posture information. The reference posture information includes a reference coordinate of the key point.

According to embodiments of the present disclosure, the reference posture information is, for example, a pre-defined information used as a reference. Taking the target object being a human body as an example, the reference posture may be, for example, a posture of the human body in an upright state. In this case, for example, the reference coordinate of each key skeleton point of the human body may be determined based on a determined coordinate system. Then, according to the reference coordinate of each key skeleton point, a change amount of the coordinate of the key skeleton point of the human body in the video frame relative to the reference coordinate may be determined. The change amount may be represented by the rotation angle of the skeleton point. For example, the posture information of the human body in the video frame may be determined according to the change amount.

FIG. 4 schematically shows a structural diagram of a second neural network model according to embodiments of the present disclosure.

According to embodiments of the present disclosure, a real posture information of a target object in each video frame may be used to train a second neural network model 400. The real posture information of the target object may be determined according to a change amount of the real key point coordinate of the target object in each video frame relative to a reference posture information. The real posture information may be in a form of a length of the skeleton and a rotation angle of the skeleton. Therefore, the output of the second neural network model is the posture information including the length of the skeleton and the rotation angle of the skeleton and the like.

As shown in FIG. 4, the second neural network model may take an initial video frame 310 and the key point coordinate 350 output by the first neural network model as input, and then cut the video frame 310 into an appropriate size according to the key point coordinate 350 to obtain a target image, such as a human body image. After that, a feature extraction and a dimension reduction are performed on the human body image by using the CNN (Convolutional Neural Network) module 410, and the human body images corresponding to consecutive video frames are processed by using the GRU (Gated Recurrent Unit) module 420, so as to learn a hidden state feature in the human body image. The features obtained as above may be output to the Regressor module 430, and after several iterations, for example, the length of the skeleton of the human body in the corresponding human body image, and the posture information 440 such as the rotation angle of the skeleton relative to the reference posture information may be obtained. Therefore, the posture information of the human body in the image may be determined according to the reference posture information and the posture information such as the length of the skeleton and the rotation angle of the skeleton. The posture information may represent, for example, the three-dimensional posture information of the human body in the image.

According to embodiments of the present disclosure, taking the target object being a human body as an example, the posture information includes the length of the skeleton and the rotation angle of the skeleton. The rotation angle of the skeleton is a rotation angle of a skeleton relative to the reference posture. Therefore, according to the plurality of video frames and the key point coordinate of the target object in the video frame, the method for obtaining the posture information of the target object may be applied to the field of human posture detection. By using the second neural network model shown in FIG. 4, for example, the three-dimensional coordinate of the key skeleton point of the human body in the input video including the human body may be obtained, so that the three-dimensional posture of the human body in the video frame may be further determined.

In the above-mentioned embodiments of the present disclosure, the three-dimensional extraction of the key point coordinate of the target object in the video frame is implemented, and the extraction process is implemented automatically, effectively saving the human labor and the time cost in obtaining the motion capture data.

According to embodiments of the present disclosure, the obtaining an attribute information of the target object in the video frame according to the key point coordinate of the target object in the video frame includes: determining the attribute information of the target object in the video frame according to the key point coordinate of the target object in the video frame and key point coordinate of the target object in N video frames adjacent to the video frame. N is an integer greater than 1.

According to embodiments of the present disclosure, in a case that the video frames are stored in the order adapted to play the video frames, the N video frames adjacent to one video frame include, for example, i video frames located before the determined video frame and adjacent to the determined video frame, and N−i video frames located after the determined video frame and adjacent to the determined video frame, 0≤i≤N. For example, in the case that the determined video frame is the first video frame, the N video frames adjacent to the video frame may include N video frames located after the video frame and adjacent to the video frame. The determination of N+1 video frames may be achieved by setting a sliding window having a size of N+1.

According to an embodiment of the present disclosure, the attribute information of the target object in the video frame, for example, may be determined according to the video frame in combination with N video frames adjacent to video frame. By sliding a sliding window from the first video frame to the last video frame, the attribute information of the target object in the video frame may be determined.

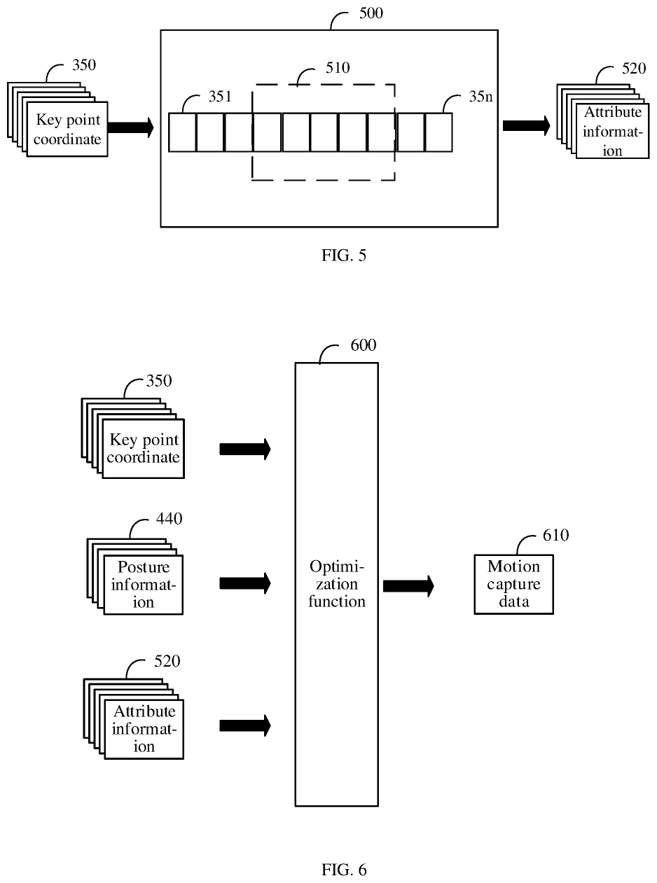

FIG. 5 schematically shows a principle diagram of a third neural network model according to embodiments of the present disclosure.

As shown in FIG. 5, the third neural network model 500 may take the key point coordinate 350 output by the first neural network model as input, and then use a sliding window 510 to superimpose of key points 351, 352 . . . 35n in a plurality of frames. An attribute information 520 of the target object in at least one of the video frames may be determined by performing a feature extraction on the key points 351, 352 . . . 35n in the plurality of frames. 351, 352 . . . 35n may represent, for example, the plurality of video frames including the key point coordinate.

According to embodiments of the present disclosure, the attribute information is used to represent an information of contact state between the target object and a predetermined medium, and the predetermined medium includes a ground. The method for obtaining the attribute information of the target object in the video frame according to the key point coordinate of the target object in the video frame may be applied to the field of human posture detection. By using the third neural network model shown in FIG. 5, for example, the contact state between the human body and the ground in the input video frame including the human body may be obtained. For example, output 0 means that the human body is in contact with the ground, and output 1 means that the human body is not in contact with the ground. In this way, the information surrounding environment to which the human posture in the video frame belongs may be further determined.

According to the above embodiments of the present disclosure, the intelligent extraction of the associated attribute of the target object in the video frame is implemented, and the human labor cost and the time cost of data acquisition are saved, while the integrity of the motion capture data is improved.

According to embodiments of the present disclosure, the method for generating motion capture data may further include: obtaining optimized motion capture data according to a relative position coordinate of the target object in the video frame, a parameter of a video capture device, the key point coordinate, the posture information and the attribute information. The relative position coordinate is configured to represent a position coordinate of the target object in the video frame relative to the video capture device.

According to embodiments of the present disclosure, the video capture device includes, for example, a camera and other devices or electronic devices including a camera, and the parameter of the video capture device may include, for example, a function used to represent a camera projection model, a camera focal length and other parameters. In this case, the relative position coordinate represents, for example, a spatial position of the target object in each frame of video relative to a camera that captures the video and has a certain focal length.

According to embodiments of the present disclosure, for example, a parameter used to represent the relative position coordinate, a parameter used to represent the camera projection model, a parameter used to represent the key point coordinate, a parameter used to represent the attribute information, and a parameter used to represent the posture information may be used as an independent variable, and an optimized posture information is used as a dependent variable, so as to construct an optimization function. Then, for example, the key point coordinate output by the first neural network model, the posture information output by the second neural network model, and the attribute information output by the third neural network model are input into the optimization function, so as to obtain the optimized posture information as the optimized motion capture data.

In the above embodiments of the present disclosure, by introducing the optimization function, the accuracy of the acquired motion capture data may be further improved.

According to embodiments of the present disclosure, the obtaining optimized motion capture data according to a relative position coordinate of the target object in the video frame, a parameter of a video capture device, the key point coordinate, the posture information and the attribute information includes: determining a predicted two-dimensional key point coordinate of the target object and an initial correlation coefficient according to initial motion capture data. A real two-dimensional key point coordinate of the target object is determined according to a pixel coordinate of the target object in the video frame. The initial correlation coefficient is adjusted according to a degree of matching between the predicted two-dimensional key point coordinate and the real two-dimensional key point coordinate, in order to obtain a target correlation coefficient. In addition, the optimized motion capture data is obtained according to the parameter of the video capture device, the key point coordinate, the posture information, the attribute information and the target correlation coefficient.

According to embodiments of the present disclosure, the initial motion capture data is, for example, a three-dimensional posture information calculated based on an initial optimization function, and a correlation coefficient in the initial optimization function is, for example, a self-defined initial correlation coefficient. The correlation coefficient may include a correlation coefficient related to parameters such as the parameter used to represent the relative position coordinate, the parameter used to represent the camera projection model, the parameter used to represent the key point coordinate, the parameter used to represent the attribute information and the parameter used to represent the posture information. In order to match the predicted two-dimensional key point coordinate of the three-dimensional posture information calculated by the optimization function with the real two-dimensional key point coordinate, the value of the correlation coefficient in the optimization function may be adjusted. For example, the correlation coefficient may be determined by verifying that, when the correlation coefficient in the optimization function is the target correlation coefficient, the three-dimensional posture information calculated based on the optimization function having the target correlation coefficient may be the optimized motion capture data.

FIG. 6 schematically shows a schematic diagram of determining optimized motion capture data based on an optimization function according to embodiments of the present disclosure;

As shown in FIG. 6, a parameter used to represent the relative position coordinate, a parameter used to represent the camera projection model, a parameter used to represent the key point coordinate, a parameter used to represent the attribute information, and a parameter used to represent the posture information may be used as an independent variable, and an optimized posture information is used as a dependent variable, so as to construct an optimization function 600. The parameter used to represent the relative position coordinate and the parameter used to represent the camera projection model may have a fixed value or may be adjusted adaptively. The correlation coefficient may be a target correlation coefficient that has been verified for the optimization function to achieve the optimization effect. Based on the optimization function 600, combined with input values such as the key point coordinate 350 output by the first neural network model, the posture information 440 output by the second neural network model, and the attribute information 520 output by the third neural network model, the optimized three-dimensional posture information may be calculated, so as to determine the optimized motion capture data 610. In this way, the obtained motion capture data 610 may represent, for example, the three-dimensional posture of the target object relative to the actual spatial position of the camera or other device represented by the predetermined camera projection model.

The above-mentioned embodiments of the present disclosure provides a method for determining an optimization function, in which by adjusting the correlation coefficient in the optimization function, the motion capture data with higher accuracy may be further calculated according to the optimization function with the adjusted correlation coefficient.

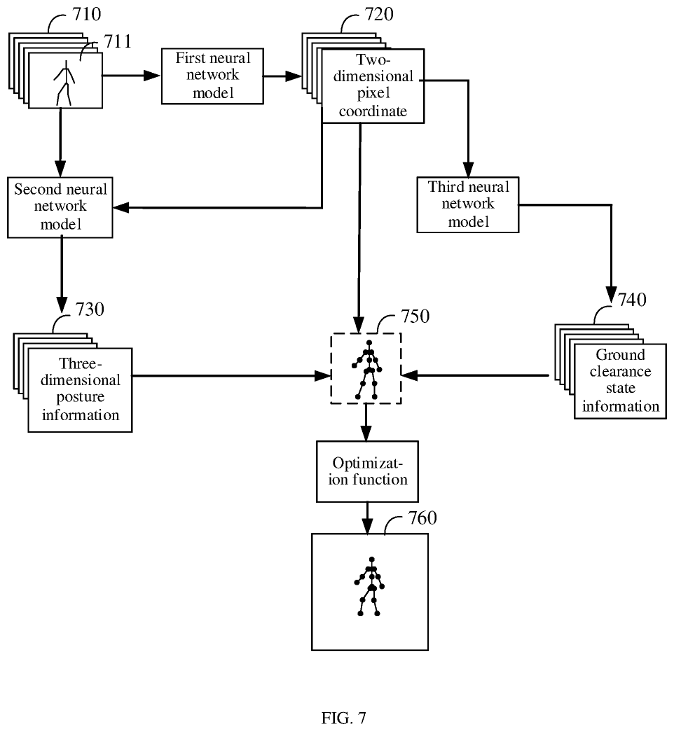

FIG. 7 schematically shows a schematic diagram of generating motion capture data based on a video containing a human body according to embodiments of the present disclosure.

As shown in FIG. 7, the video frame(s) 710 may be, for example, a plurality of video frames corresponding to a video including a human motion or at least one of the plurality of video frames. The first neural network model which has been trained as described above is used to process the video frames 710, so as to obtain, for example, a two-dimensional pixel coordinate 720 of a key skeleton point of a dancer in at least one video frame. The second neural network model which has been trained as described above is used to further process the video frames 710 and the two-dimensional pixel coordinate 720, so as to obtain, for example, a three-dimensional posture information 730 corresponding to a certain motion of the dancer. The third neural network model is used to process the two-dimensional pixel coordinate 720, so as to obtain, for example, a ground clearance state information 740 of the dancer. Next, for example, a skeleton configuration may be performed according to the two-dimensional pixel coordinate 720, the three-dimensional posture information 730 and the ground clearance state information 740, so as to obtain the motion capture data for representing human motion in at least one video frame. 750 and 760 represent, for example, the human motion represented by the motion capture data which has not been optimized and the human motion represented by the motion capture data which have been optimized, respectively.

According to embodiments of the present disclosure, referring to FIG. 7, for example, a certain video frame among the video frames 710 includes a human motion as denoted by 711. Then, the skeleton configuration is performed according to the two-dimensional pixel coordinate 720, the three-dimensional posture information 730 and the ground clearance state information 740 related to the video frame, so as to initially obtain, for example, the motion capture data representing the human motion as denoted by 750 in FIG. 7. By performing the skeleton configuration according to the two-dimensional pixel coordinate 720, the three-dimensional posture information 730 and the ground clearance state information 740 related to the video frame based on the optimization function including the target correlation coefficient, for example, the motion capture data representing human motion as denoted by 760 in FIG. 7 may be obtained. Since 760 has a greater degree of similarity with 711, the motion-captured data represented by the human motion denoted by 760 in FIG. 7 may be used as the motion-captured data.

In the above-mentioned embodiments of the present disclosure, it is possible to obtain the motion capture data through video input, so as to be used directly to drive the virtual character or be simply edited and then used to drive the virtual character. With the method for generating motion capture data, the requirement in terms of time, professional ability, site and equipment investment is reduced, so as to allow ordinary users to generate and edit the motion of 3D models at any place. With this method, body movements of the virtual character may be automatically generated, and users and third parties are allowed to generate and share the motions, so that motions of the virtual character that are selectable by the user may be generated without the need of constructing a database by manual editing or motion capture. In addition, the motion capture data generated according to the method may also be used in other fields such as virtual character motion data generation and human body posture recognition.

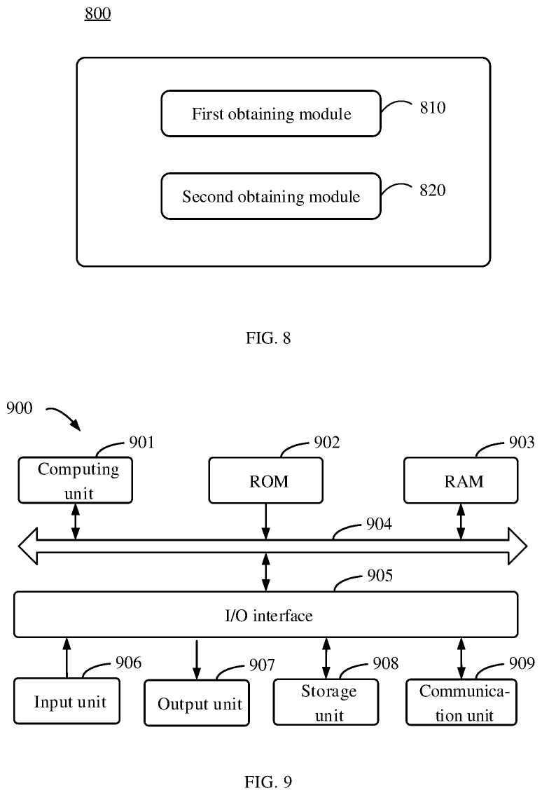

FIG. 8 schematically shows a block diagram of an apparatus for generating motion capture data according to embodiments of the present disclosure.

As shown in FIG. 8, the apparatus 800 for generating motion capture data includes a first obtaining module 810 and a second obtaining module 820.

The first obtaining module 810 is configured to process a plurality of video frames including a target object to obtain a key point coordinate of the target object in at least one of the video frames.

The second obtaining module 820 is configured to obtain, as motion capture data for the target object, a posture information of the target object according to the plurality of video frames and the key point coordinate of the target object in the video frame.

According to embodiments of the present disclosure, the apparatus for generating motion capture data further includes a third obtaining module and a determining module.

The third obtaining module is configured to obtain an attribute information of the target object in the video frame according to the key point coordinate of the target object in the video frame.

The determining module is configured to determine the motion capture data for the target object according to the key point coordinate, the attribute information and the posture information.

According to embodiments of the present disclosure, the first obtaining module includes a first determining unit and a first obtaining unit.

The first determining unit is configured to perform an object detection on the plurality of video frames to determine the target object in the at least one of the video frames.

The first obtaining unit is configured to detect the target object to obtain the key point coordinate of the target object.

According to embodiments of the present disclosure, the second obtaining module includes a second obtaining unit, a third obtaining unit and a second determining unit.

The second obtaining unit is configured to extract the target object in the video frame according to the key point coordinate of the target object in the video frame, to obtain a target image.

The third obtaining unit is configured to perform a feature extraction on the target image to obtain a target feature.

The second determining unit is configured to determine the posture information according to the target feature and a reference posture information, wherein the reference posture information includes a reference coordinate of the key point.

According to embodiments of the present disclosure, the third obtaining module includes a third determining unit.

The third determining unit is configured to determine the attribute information of the target object in the video frame according to the key point coordinate of the target object in the video frame and key point coordinate of the target object in N video frames adjacent to the video frame, wherein N is an integer greater than 1.

According to embodiments of the present disclosure, the apparatus for generating motion capture data further includes a fourth obtaining module.

The fourth obtaining module is configured to obtain optimized motion capture data according to a relative position coordinate of the target object in the video frame, a parameter of a video capture device, the key point coordinate, the posture information and the attribute information; wherein the relative position coordinate is configured to represent a position coordinate of the target object in the video frame relative to the video capture device.

According to embodiments of the present disclosure, the fourth obtaining module includes a fourth determining unit, a fifth determining unit, an adjusting unit and a fourth obtaining unit.

The fourth determining unit is configured to determine a predicted two-dimensional key point coordinate of the target object and an initial correlation coefficient according to initial motion capture data.

The fifth determining unit is configured to determine a real two-dimensional key point coordinate of the target object according to a pixel coordinate of the target object in the video frame.

The adjusting unit configured to adjust the initial correlation coefficient to obtain a target correlation coefficient according to a degree of matching between the predicted two-dimensional key point coordinate and the real two-dimensional key point coordinate; and

The fourth obtaining unit is configured to obtain the optimized motion capture data according to the parameter of the video capture device, the key point coordinate, the posture information, the attribute information and the target correlation coefficient.

According to embodiments of the present disclosure, the key point coordinate is configured to represent a pixel coordinate of a target skeleton point of the target object in the video frame.

According to embodiments of the present disclosure, the posture information includes a rotation angle of a skeleton and a length of the skeleton, and the rotation angle of the skeleton is a rotation angle of the skeleton relative to a reference posture.

According to embodiments of the present disclosure, the attribute information is configured to represent an information of contact state between the target object and a predetermined medium, and the predetermined medium includes a ground.

According to embodiments of the present disclosure, the present disclosure also provides an electronic device, a readable storage medium, and a computer program product.

According to embodiments of the present disclosure, an electronic device is provided, including: at least one processor; and a memory communicatively connected with the at least one processor; wherein the memory stores instructions executable by the at least one processor, and the instructions, when executed by the at least one processor, cause the at least one processor to perform the above-mentioned method.

According to embodiments of the present disclosure, a non-transitory computer-readable storage medium storing computer instructions is provided, wherein the computer instructions are configured to cause the computer to perform the above-mentioned method.

According to embodiments of the present disclosure, a computer program product including a computer program is provided, wherein the computer program, when executed by a processor, implements the above-mentioned method.

FIG. 9 shows a schematic block diagram of an example electronic device 900 used to implement embodiments of the present disclosure. The electronic device is intended to represent various forms of digital computers, such as laptop computers, desktop computers, workstations, personal digital assistants, servers, blade servers, mainframe computers and other suitable computers. The electronic device may also represent various forms of mobile devices, such as personal digital processing, cellular phones, smart phones, wearable devices and other similar computing devices. The components shown herein, their connections and relationships, and their functions are merely examples, and are not intended to limit the implementation of the present disclosure described and/or required herein.

As shown in FIG. 9, the device 900 includes a computing unit 901, which may execute various appropriate actions and processing according to a computer program stored in a read only memory (ROM) 902 or a computer program loaded from a storage unit 908 into a random access memory (RAM) 903. Various programs and data required for the operation of the device 900 may also be stored in the RAM 903. The computing unit 901, the ROM 902 and the RAM 903 are connected to each other through a bus 904. An input/output (I/O) interface 905 is also connected to the bus 904.

The I/O interface 905 is connected to a plurality of components of the device 900, including: an input unit 906, such as a keyboard, a mouse, etc.; an output unit 907, such as various types of displays, speakers, etc.; a storage unit 908, such as a magnetic disk, an optical disk, etc.; and a communication unit 909, such as a network card, a modem, a wireless communication transceiver, etc. The communication unit 909 allows the device 900 to exchange information/data with other devices through the computer network such as the Internet and/or various telecommunication networks.

The computing unit 901 may be various general-purpose and/or special-purpose processing components with processing and computing capabilities. Some examples of computing unit 901 include, but are not limited to, central processing unit (CPU), graphics processing unit (GPU), various dedicated artificial intelligence (AI) computing chips, various processors that run machine learning model algorithms, digital signal processing DSP and any appropriate processor, controller, microcontroller, etc. The computing unit 901 executes the various methods and processes described above, such as the method for generating motion capture data. For example, in embodiments, the method for generating motion capture data may be implemented as computer software programs, which are tangibly contained in the machine-readable medium, such as the storage unit 908. In embodiments, part or all of the computer program may be loaded and/or installed on the device 900 via the ROM 902 and/or the communication unit 909. When the computer program is loaded into the RAM 903 and executed by the computing unit 901, one or more steps of the method for generating motion capture data described above may be executed. Alternatively, in other embodiments, the computing unit 901 may be configured to execute the method for generating motion capture data in any other suitable manner (for example, by means of firmware).

Various implementations of the systems and technologies described in the present disclosure may be implemented in digital electronic circuit systems, integrated circuit systems, field programmable gate arrays (FPGA), application specific integrated circuits (ASIC), application-specific standard products (ASSP), system-on-chip SOC, load programmable logic device (CPLD), computer hardware, firmware, software and/or their combination. The various implementations may include: being implemented in one or more computer programs, the one or more computer programs may be executed and/or interpreted on a programmable system including at least one programmable processor, the programmable processor may be a dedicated or general programmable processor. The programmable processor may receive data and instructions from a storage system, at least one input device and at least one output device, and the programmable processor transmit data and instructions to the storage system, the at least one input device and the at least one output device.

The program code used to implement the method of the present disclosure may be written in any combination of one or more programming languages. The program codes may be provided to the processors or controllers of general-purpose computers, special-purpose computers or other programmable data processing devices, so that the program code enables the functions/operations specific in the flowcharts and/or block diagrams to be implemented when the program code executed by a processor or controller. The program code may be executed entirely on the machine, partly executed on the machine, partly executed on the machine and partly executed on the remote machine as an independent software package, or entirely executed on the remote machine or server.

In the context of the present disclosure, the machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage media would include electrical connections based on one or more wires, portable computer disks, hard disks, random access memory (RAM), read only memory (ROM), erasable programmable read only memory (EPROM or flash memory), optical fiber, portable compact disk read only memory (CD-ROM), optical storage device, magnetic storage device or any suitable combination of the above-mentioned content.

In order to provide interaction with users, the systems and techniques described here may be implemented on a computer, the computer includes: a display device (for example, a CRT (cathode ray tube) or LCD (liquid crystal display) monitor) for displaying information to the user; and a keyboard and a pointing device (for example, a mouse or trackball). The user may provide input to the computer through the keyboard and the pointing device. Other types of devices may also be used to provide interaction with users. For example, the feedback provided to the user may be any form of sensory feedback (for example, visual feedback, auditory feedback or tactile feedback); and any form (including sound input, voice input, or tactile input) may be used to receive input from the user.

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation of the system and technology described herein), or in a computing system including any combination of such back-end components, middleware components or front-end components. The components of the system may be connected to each other through any form or medium of digital data communication (for example, a communication network). Examples of communication networks include: local area network (LAN), wide area network (WAN) and the Internet.

The computer system may include a client and a server. The client and the server are generally far away from each other and usually interact through the communication network. The relationship between the client and the server is generated by computer programs that run on the respective computers and have a client-server relationship with each other. The server may be a cloud server, a server of a distributed system, or a server combined with a block chain.

It should be understood that the various forms of processes shown above may be used to reorder, add or delete steps. For example, the steps described in the present disclosure may be executed in parallel, sequentially or in a different order, as long as the desired result of the present disclosure may be achieved, which is not limited herein.

The above-mentioned specific implementations do not constitute a limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for generating motion capture data, the method comprising:
processing a plurality of video frames comprising a target object to obtain a key point coordinate of the target object in at least one of the video frames; and
obtaining, as motion capture data for the target object, a posture information of the target object according to the plurality of video frames and the key point coordinate of the target object in the video frame.

2. The method according to claim 1, further comprising:
obtaining an attribute information of the target object in the video frame according to the key point coordinate of the target object in the video frame; and
determining the motion capture data for the target object according to the key point coordinate, the attribute information and the posture information.

3. The method according to claim 1, wherein the processing a plurality of video frames comprising a target object to obtain a key point coordinate of the target object in at least one of the video frames comprises:
performing an object detection on the plurality of video frames to determine the target object in the at least one of the video frames; and
detecting the target object to obtain the key point coordinate of the target object.

4. The method according to claim 1, wherein the obtaining a posture information of the target object according to the plurality of video frames and the key point coordinate of the target object in the video frame comprises:
extracting the target object in the video frame according to the key point coordinate of the target object in the video frame, to obtain a target image;
performing a feature extraction on the target image to obtain a target feature; and
determining the posture information according to the target feature and a reference posture information, wherein the reference posture information comprises a reference coordinate of the key point.

5. The method according to claim 2, wherein the obtaining an attribute information of the target object in the video frame according to the key point coordinate of the target object in the video frame comprises determining the attribute information of the target object in the video frame according to the key point coordinate of the target object in the video frame and key point coordinate of the target object in N video frames adjacent to the video frame, wherein N is an integer greater than 1.

6. The method according to claim 2, further comprising obtaining optimized motion capture data according to a relative position coordinate of the target object in the video frame, a parameter of a video capture device, the key point coordinate, the posture information and the attribute information, wherein the relative position coordinate is configured to represent a position coordinate of the target object in the video frame relative to the video capture device.

7. The method according to claim 6, wherein the obtaining optimized motion capture data according to a relative position coordinate of the target object in the video frame, a parameter of a video capture device, the key point coordinate, the posture information and the attribute information comprises:
determining a predicted two-dimensional key point coordinate of the target object and an initial correlation coefficient according to initial motion capture data;
determining a real two-dimensional key point coordinate of the target object according to a pixel coordinate of the target object in the video frame;
adjusting the initial correlation coefficient to obtain a target correlation coefficient according to a degree of matching between the predicted two-dimensional key point coordinate and the real two-dimensional key point coordinate; and
obtaining the optimized motion capture data according to the parameter of the video capture device, the key point coordinate, the posture information, the attribute information and the target correlation coefficient.

8. The method according to claim 2, wherein the attribute information is configured to represent an information of contact state between the target object and a predetermined medium, and the predetermined medium comprises a ground.

9. The method according to claim 1, wherein the key point coordinate is configured to represent a pixel coordinate of a target skeleton point of the target object in the video frame.

10. The method according to claim 1, wherein the posture information comprises a rotation angle of a skeleton and a length of the skeleton, and the rotation angle of the skeleton is a rotation angle of the skeleton relative to a reference posture.

11. An electronic device, comprising:
at least one processor; and
a memory communicatively connected with the at least one processor, wherein the memory stores instructions executable by the at least one processor, and the instructions, when executed by the at least one processor, configured to cause the at least one processor to at least perform the method of claim 1.

12. The electronic device according to claim 11, wherein the instructions are further configured to cause the at least one processor to:
obtain an attribute information of the target object in the video frame according to the key point coordinate of the target object in the video frame; and
determine the motion capture data for the target object according to the key point coordinate, the attribute information and the posture information.

13. The electronic device according to claim 11, wherein the instructions are further configured to cause the at least one processor to:
perform an object detection on the plurality of video frames to determine the target object in the at least one of the video frames; and
detect the target object to obtain the key point coordinate of the target object.

14. The electronic device according to claim 11, wherein the instructions are further configured to cause the at least one processor to:
extract the target object in the video frame according to the key point coordinate of the target object in the video frame, to obtain a target image;
perform a feature extraction on the target image to obtain a target feature; and
determine the posture information according to the target feature and a reference posture information, wherein the reference posture information comprises a reference coordinate of the key point.

15. The electronic device according to claim 12, wherein the instructions are further configured to cause the at least one processor to determine the attribute information of the target object in the video frame according to the key point coordinate of the target object in the video frame and key point coordinate of the target object in N video frames adjacent to the video frame, wherein N is an integer greater than 1.

16. The electronic device according to claim 12, wherein the instructions are further configured to cause the at least one processor to obtain optimized motion capture data according to a relative position coordinate of the target object in the video frame, a parameter of a video capture device, the key point coordinate, the posture information and the attribute information, wherein the relative position coordinate is configured to represent a position coordinate of the target object in the video frame relative to the video capture device.

17. The electronic device according to claim 16, wherein the instructions are further configured to cause the at least one processor to:
determine a predicted two-dimensional key point coordinate of the target object and an initial correlation coefficient according to initial motion capture data;
determine a real two-dimensional key point coordinate of the target object according to a pixel coordinate of the target object in the video frame;
adjust the initial correlation coefficient to obtain a target correlation coefficient according to a degree of matching between the predicted two-dimensional key point coordinate and the real two-dimensional key point coordinate; and
obtain the optimized motion capture data according to the parameter of the video capture device, the key point coordinate, the posture information, the attribute information and the target correlation coefficient.

18. The electronic device according to claim 12, wherein the attribute information is configured to represent an information of contact state between the target object and a predetermined medium, and the predetermined medium comprises a ground.

19. The electronic device according to claim 11, wherein the key point coordinate is configured to represent a pixel coordinate of a target skeleton point of the target object in the video frame, and
wherein the posture information comprises a rotation angle of a skeleton and a length of the skeleton, and the rotation angle of the skeleton is a rotation angle of the skeleton relative to a reference posture.

20. A non-transitory computer-readable storage medium storing computer instructions therein, the computer instructions, when executed by a computer system, configured to cause the computer system to at least perform the method of claim 1.
